(19) United States
(12) Patent Application Publication
(10) Pub. No.: US 2010/0306190 A1
(43) Pub. Date: Dec. 2, 2010

(54) Retrieval-Time Ranking for Community Content

(76) Inventors: Cam Turner, Waterloo (CA); Victor Summer, Kitchener (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/474,359

(22) Filed: May 29, 2009

(51) Int. Cl. G06F 17/30

(52) U.S. Cl. 707/723; 707/E17.014

(57) ABSTRACT

A computer-implemented method and system of establishing, accessing, ranking and retrieving community-oriented content, the community content selected from a plurality of content items available at a content database for presentation at a client device. The method involves establishing a physical proximity of the client device to each of the content items available at the content database; establishing a freshness of the respective ones of the content items relative to the time of a request for the community content at the client device, computing an aggregated score, and ranking the content items to be presented at the client device, the aggregated score at least partially based on the physical proximity and the freshness.

### FIELD OF THE INVENTION

The present invention relates to a method and computer system for establishing and retrieving community-oriented content for presentation at a client device.

### BACKGROUND OF THE INVENTION

In the current environment of digital communications, a great deal of electronic information may be available to a user of a connected computing device. The magnitude of the accessible information from the internet, for example, may so overwhelming that it is becoming more and more important to provide processes for retrieval of information in such a way as to recover only the most pertinent information, customized or personalized for a given user.

Given the current trend, for instance, of newspapers favoring more and more national coverage at the expense of local or community coverage, many new sources of local or community news are appearing online to fill the void. Discovering where these sources are and following them all can be a big challenge for a user.

Most search engines used for retrieval of electronic information are dependent on a user inputting a particular text string describing the requested content, and then processing the content to find material which relates to the search string. The relevance or desirability of the retrieved content to user may be limited by the particular key words that a user inputs as the search text string. For retrieved content to be most relevant to a reader, this may mean more than simply responding to a text-string based query initiated at a connected client device by the user. For instance, where a user is interested in search results related to content or information pertinent only to his or her locality or community, any search results retrieved need to take into account the community context, such context typically not specified explicitly via a text-based search string.

With regard to identification or designation of a community, it should be kept in mind that politically-based boundaries do not always define local or community interest. For instance, in a large, populous city, there may exist multiple neighborhood or local communities within even a single segment of such a city. On the other hand, for sparsely populated regions or states, a “community” may be considered to encompass hundreds of square miles, even across state boundaries. Thus geographical proximity, taken in isolation, may not be an effective way of identifying a community.

Even UNESCO (United Nations Educational, Scientific and Cultural Organization) recognizes the power and impact local content has on a participating community: “Local content is the expression and communication of a community's locally owned and adapted knowledge and experience that is relevant to the community's situation. The process of creating and disseminating local content provides opportunities for members of the community to interact and communicate with each other, expressing their own ideas, knowledge and culture. A community is defined by its location, culture, language, or area of interest. Thus, a community may comprise of a handful of people or include millions. Communities are not static or exclusive and individuals may belong to many communities at the same time.” (http:portal.unesco.org/ci/en/ev.php-URL_ID=4237)

By combining the local and community news sections, for example, from newspapers, television stations and radio stations with prominent local blogs, local sporting events, reviews of local restaurants, and other “town hall” news sources, users may ostensibly have access to a web portal-based source to keep abreast of the news that relates exclusively to their community. A challenge still remains, however, as to how to parse the most relevant community-oriented information from the overall population of information that is retrieved consequent to a user request.

### SUMMARY OF THE INVENTION

There is provided a computer-implemented method, executed in a processor, of retrieving community content, the community content selected from respective ones of content items available at a content database for presentation at a client device, the method comprising: establishing a physical proximity of the client device to the respective ones of the content items available at the content database; establishing a freshness of the respective ones of the content items relative to a time of a request for the community content at the client device; computing an aggregated score; and ranking the respective ones of the content items to be presented at the client device according to the respective aggregated score, the aggregated score at least partially based on the physical proximity and the freshness.

In another embodiment, establishing the physical proximity of the client device to respective ones of the content items available at the content database further comprises: establishing a client device location of the client device requesting retrieval of community content from a content database; establishing an author location for each of the respective content items at a time of publication of the respective ones of the content items; and determining a distance between the client device location and each of the respective author locations of the content items.

The method, in another embodiment, may further comprise computing a proximity score based on the determined distance.

In yet another embodiment, the method may comprise computing the aggregated score at least partially based on the proximity score.

There is provided a further embodiment wherein establishing the freshness of the respective ones of the content items further comprises establishing time of publication at the content database of the respective content items.

In another embodiment, the method may further comprise computing a freshness score based on the freshness of the respective content items.

In yet another embodiment, the method may comprise computing the aggregated score at least partially based on the freshness score.

In a further embodiment, the aggregated score may be at least partially based on a uniqueness score of the respective ones of the content items.

In an alternate embodiment, the aggregated score may be at least partially based on an editorial popularity score of the respective ones of the content items.

The method, in another embodiment, may further comprise: presenting the ranked content items at the client device according to the rankings.

In another alternate embodiment, the method may comprise creating a display page at the client device, the display page incorporating the ranked content items in a pre-arranged format for display at the display page.

There is provided, in an alternate embodiment, a computer system comprising: a proximity module to establish a location of a client device requesting retrieval of community content available at a content database and to establish a location of each of the respective ones of content items comprising the community content; a freshness module to establish a freshness of the respective ones of the content items relative to a time of the request for the community content at the client device; and a scoring module having program code to rank the content items at the time of the request at the client device; wherein the content items are ranked for presentation at the client device at least partially based on (i) a physical proximity of the client device to the respective ones of the content items, and (ii) the freshness of the respective ones of the content items.

In a further embodiment of the computer system, the scoring module comprises program code to compute an aggregated score for ranking the respective ones of the content items at the time of request for community content from the client device, the aggregated score at least partially based on (i) a physical proximity of the client device to the respective ones of the content items, and (ii) the freshness of the respective ones of the content items.

In yet another embodiment of the computer system, the scoring module comprises program code to compute an aggregated score for ranking the respective ones of the content items at the time of request for community content from the client device, the aggregated score at least partially based on a uniqueness score of the respective ones of the content items.

There is provided yet another embodiment of the computer system wherein the scoring module comprises program code to compute an aggregated score for ranking the respective ones of the content items at the time of request for community content from the client device, the aggregated score at least partially based on a popularity score of the respective ones of the content items.

In another embodiment, the computer system further comprises a presentation module, the presentation module for creating a display page at the client device to display of the ranked content items according to rankings.

In yet another alternate embodiment, the computer system further comprises a presentation module, the presentation module creating a display page at the client device for display of the ranked content items according to a pre-arranged format.

### BRIEF DESCRIPTION OF THE DRAWINGS

The invention will now be described by way of example only with reference to the following drawings in which:

FIG. 1 shows an exemplary embodiment of a communication system architecture for establishing, ranking and delivering community-oriented content to a client device;

FIG. 2 shows further detail of one aspect of the exemplary embodiment of the communication system architecture of FIG. 1.

FIG. 3 provides an overview of an exemplary method for accessing, ranking and delivering community-oriented content to a client device;

FIG. 4 depicts an exemplary screenshot of a web page that may be presented to a user of a client device, in one embodiment for establishing the location of the user;

FIG. 5 shows an exemplary method for scoring and ranking content items in order to determine aggregated scores for retrieval and delivery to a client device;

FIG. 6 is an exemplary depicture of how a set of content items among the community-oriented content might be scored to enable ranking of the content items for delivery to a client device; and

FIG. 7 shows another alternate embodiment of the exemplary methods for accessing, ranking and delivering community-oriented content to a client device.

### DETAILED DESCRIPTION

Community-oriented content, or community content as described herein may incorporate content sources such as for news, businesses, places, sports and cultural announcements and events, reviews, web logs (or “blogs”) and even classified ads, that, when combined yield all of the information that people consider when thinking about community. Varied and even disparate content sources may be used in order to capture both well-known and obscure information.

The idea of community described herein encompasses more than mere locality or geographical proximity, in the context of retrieving community-oriented content. Other measures that aid in effectively capturing the sense of community for a user may include: (i) the “freshness” as well as (ii) the uniqueness and (iii) editorial popularity of a given content item during a web- or internet-based content search.

As used herein, freshness is a measure of how recent a content item has been published or made available from a content database, relative to the time of request for community content by a user of a connected computing device. It will be appreciated that most recent or timely content, or discussion and announcements therein, may be more desirable and relevant to a user.

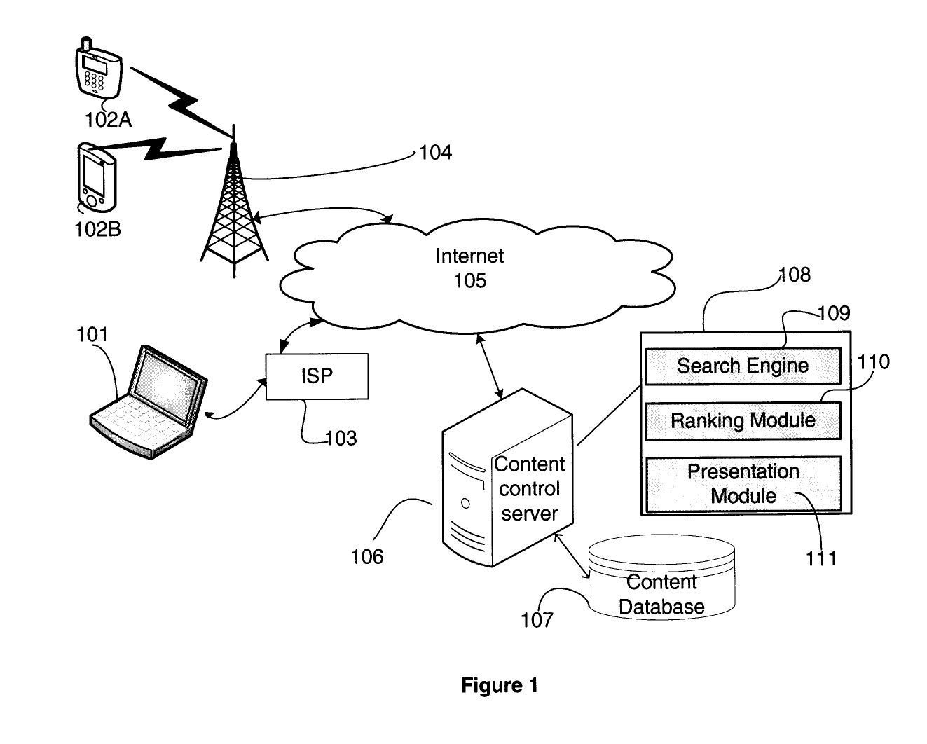

FIG. 1 shows an exemplary embodiment of a communication system architecture for establishing, ranking and delivering community-oriented content to a client device.

A client device such as a laptop or a desktop computer 101 may connect to the internet 105 or other communication network using broadband Internet Service Provider 103, via either a wired landline connection or a wireless connection, for example. Other client devices may be mobile phone 102A or Personal Digital Assistant (PDA) 102B (referred to collectively as “102” herein), able to connect to the internet 105 over cellular networks via a wireless service provider/carrier system infrastructure 104, for example. The plurality of client devices 101, 102, may be loaded with the appropriate web browsing functionality for browsing a website hosted by content control server 106.

Client device 101, 102 may be a two-way communication device having both voice and data communication capabilities, including the capability to communicate with other computer systems. Client device 101, 102 may include a communication subsystem which includes a receiver, a transmitter, and associated components, such as one or more embedded or internal antenna elements, and a processing module such as a digital signal processor (DSP). Client device 101, 102 includes a microprocessor which controls general operation of the device. The microprocessor also interacts with additional device subsystems such as a display, a flash memory, a random access memory (RAM, a keyboard, a speaker, a microphone, a short-range communications subsystem such as BLUETOOTH (Bluetooth™) for example, and any other device subsystems or peripheral devices. Client device 101, 102 may also include a positioning device, such as a GPS receiver for example. The GPS receiver may be configured to detect and provide location information in order to determine the location of the client device 101, 102. In the case of a non-location-aware desktop computer, its uniquely-assigned Internet Protocol (IP) address will be associated with a unique location of that desktop computer client device 101.

Operating system software used by the microprocessor of client device 101, 102 may be stored in a persistent store such as the flash memory, which may alternatively be a read-only memory (ROM) or similar storage element. The microprocessor, in addition to its operating system functions, may enable execution of software applications on the client device 101, 102. A predetermined set of applications may be installed on the client device 101, 102 during its manufacture. These may typically include data and voice communication applications, for example. The screen display of client device 101, 102 may be used to visually present an application's graphical user interface (GUI) to the user. The user can manipulate application data by modifying information on the GUI using an input device such as a keyboard or other types of input devices, for example, a scroll wheel, trackball, light pen or touch sensitive screen.

Content control server 106 may be owned and maintained by an Application Service Provider (ASP) which provides a website or web portal application for registered users. The ASP provides access to the content control server 106, which is able to determine and deliver relevant content to the client devices 101, 102. The web portal application may be tailored to provide relevant community-oriented information and content depending on the personal interests of a user registered with the ASP. Content control server 106 may have access to one (or more) content database(s) 107. Thus a user of client devices 102, 101 is able to search for relevant content or information stored in a database, connected via the internet 105.

The content searched may be stored on the content control server 106, content database 107, or further alternatively, the content searched may be drawn from the internet 105. It should be appreciated that content stored or searched may comprise any of a plurality of different types of content in the form of various types of files, documents and/or portions thereof which might be sorted based on their relevance to the user.

Content control server 106 may comprise a plurality of different components including a computer processor, and a content control engine 108. It should also be appreciated that the computer processor is able to execute computer programs for carrying out all of the functions of the content control engine 108 modules described herein, including Search Engine 109, Ranking Module 110 and Presentation Module 111. The Search Engine Module 109 may be able to sort through content from remote and disparate databases accessed over the internet 105 or a local database (not shown) by comparing the content against the specific requests of a user.

Presentation module 111 of content control engine 108 may comprise any combination of software, firmware or hardware to perform the function of creating a display page at the client device 101, 102 to display of the ranked content items according to rankings. In an alternate embodiment, the presentation module may also be used to create a display page at the client device for display of the ranked content items within a pre-arranged display format, or within a template for displaying the retrieved community content in ways other than simply by rankings. The template may be customizable by the user of client device 101, 102. Alternate arrangements where presentation module 111 is resident at client device 101, 102 instead of within content control server 106 are also contemplated.

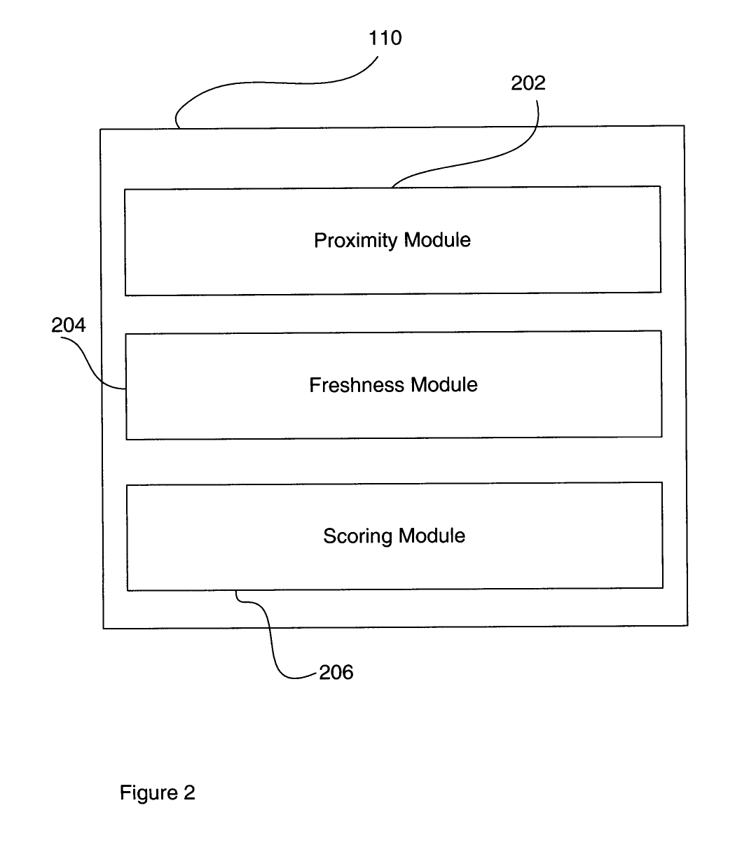

FIG. 2 shows further detail of one aspect of the exemplary embodiment of FIG. 1. More specifically, ranking module 110 may comprise proximity module 202, freshness module 204 and scoring module 206.

Ranking module 110 may comprise any combination of software, firmware and hardware to perform ranking and retrieving of community-oriented content from the content items available at 107 content database for presentation at a client device 101, 102.

Proximity module 202 may comprise any combination of software, firmware or hardware to perform the function of establishing a location of a client device 101, 102 requesting retrieval of community content available at content database 107 or content control server 106, as well as a location of each of the content items comprising the community content. Proximity module 202 may also determine a distance between the client device location and each of the respective author locations.

Freshness module 204 may comprise any combination of software, firmware or hardware to perform the function of establishing a freshness, in terms of age (hours, days) of the respective content items relative to a time of the request for the community content at the client device.

Scoring module 206 may comprise any combination of software, firmware or hardware to perform the function of quantifying the proximity, freshness, uniqueness and popularity of the content items, in order to compute an aggregated score for ranking the content items at the time of the request, for presentation at the client device.

It should be appreciated that the computer processor of content control server 106 is able to execute computer programs for carrying out all of the functions of ranking module 110, including the functions of proximity module 202, freshness module 204 and scoring module 206.

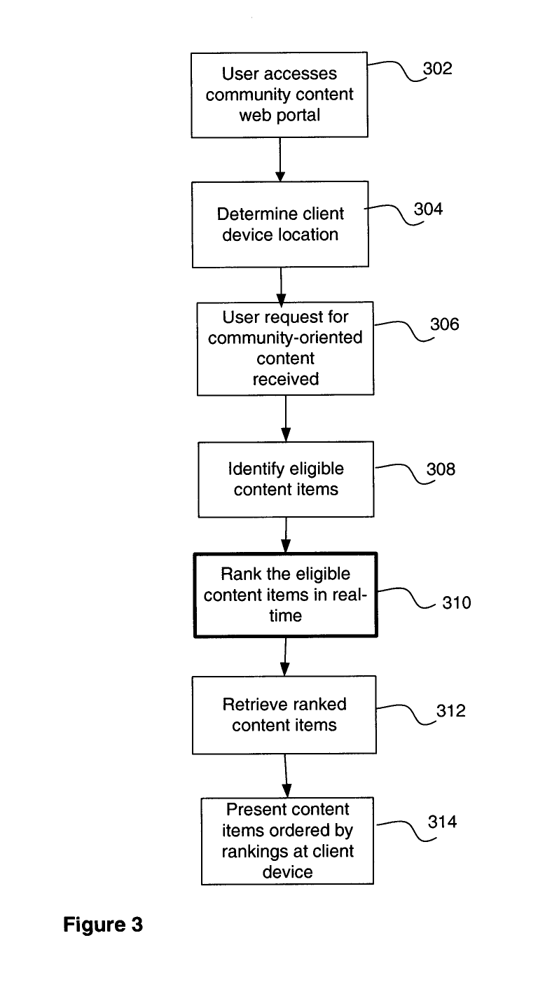

FIG. 3 provides an overview of an exemplary method for accessing, ranking and delivering community-oriented content to client device 101, 102.

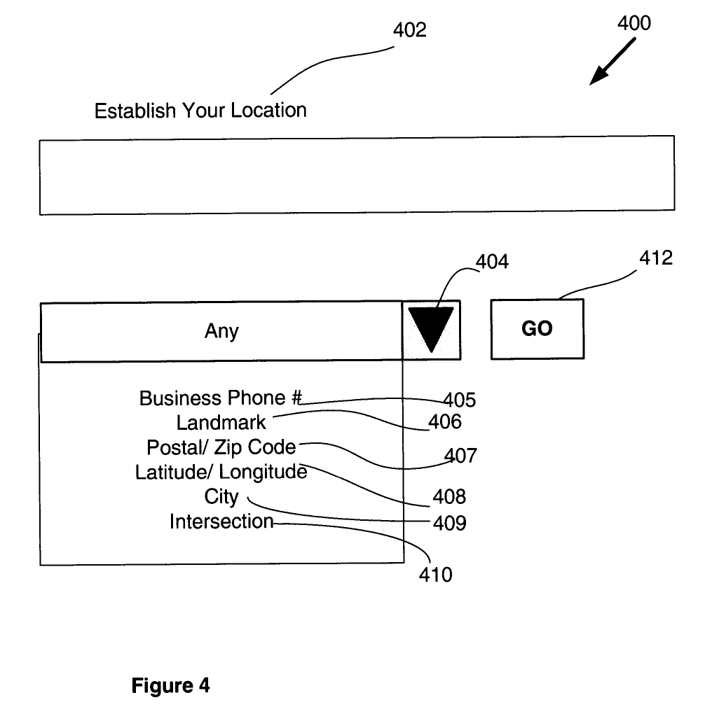

At 302, a user accesses the community content web portal via client device 101, 102. At 304, the location of the client device is determined. Location may be determined automatically if client device 101, 102 incorporates Global Positioning Systems (GPS) functionality or some version of radio frequency triangulation-based functionality. Alternately, a user may enter information sufficient to determine their location within a locality. More exemplary detail of the latter technique will be provided in FIG. 4 herein.

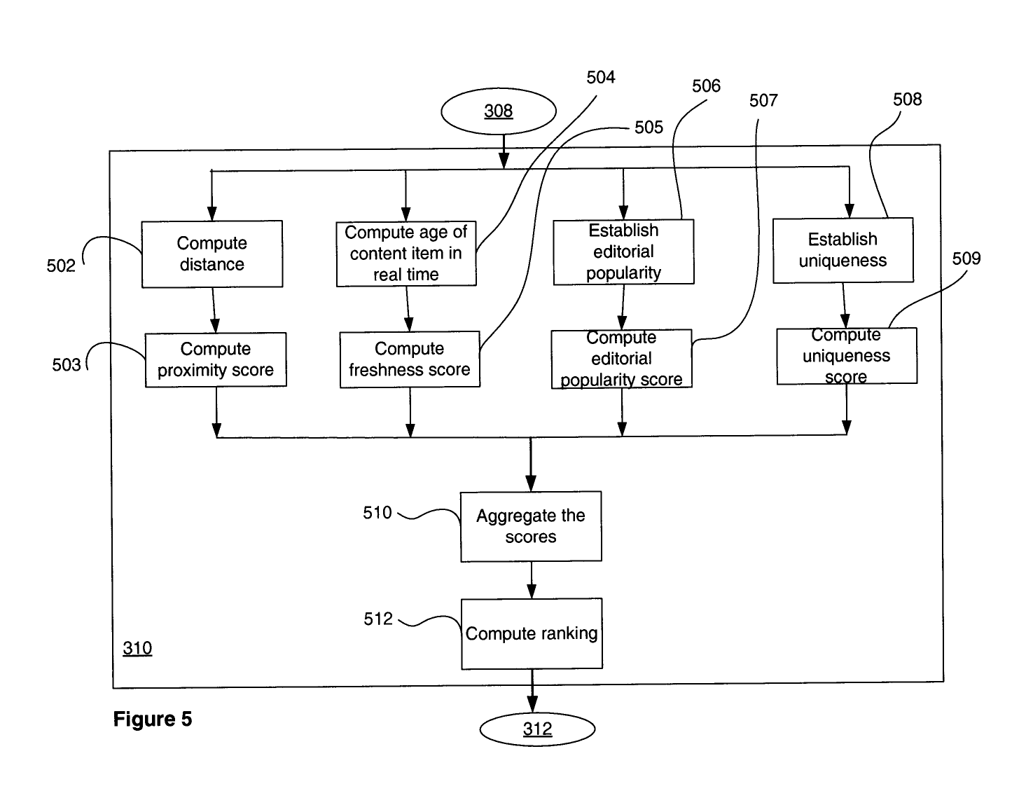

With reference again to FIG. 3, at 306 the user requests community-oriented content via client device 101, 102. At 308, the search engine module 109 of content control server 106 identifies appropriate content, based on the user's search request entered, such as based on a text search string. At 310, the content items are scored, then ranked in order of the most desirable community content for presentation to the user. More details of the scoring and ranking process, carried out in ranking module 110, are discussed below in the context of FIG. 5.

At 312 the ranked content items are retrieved from content control server 106. At 314, the ranked content is presented, in order of the rankings, at client device 101, 102.

FIG. 4 depicts an exemplary screenshot 400 of a web page that may be presented to a user of client device 101, 102, in one embodiment for establishing the location of the user. The user may be prompted via “Establish Your Location” block 402. Drop-down menu 404 may provide several choices for the user to establish location or locality. Such choices may include entering a business or landline phone number 405, a notable local landmark 406 such as “CN Tower”, a postal or zip code, a latitude/longitude coordinate 408, a city 409 or a street intersection 410. The user may select one of such choices, then activate GO command 412 to establish location of client device 101, 102. Some of these choices are inherently able to provide more accurate positioning than others, but it will be appreciated that all choices may be sufficient to establish a context for the community content desired by a user.

FIG. 5 shows an exemplary method for scoring and ranking content items among the community content, to determine aggregated scores for retrieval and delivery of the ranked content to client device 101, 102. It will be appreciated that while computations for the parameters (proximity, freshness, popularity, and uniqueness) that may be used for ranking the content to be retrieved are depicted in FIG. 5 as being done in parallel, other arrangements are contemplated; for instance, such computations may be performed serially, or in any combination of serial and parallel operations.

At 502, the physical proximity of the client device 101, 102 relative to the content item at the time of publication of the article is assessed. The location of the author at the time of publication of the content item may be provided, and used as the location of that respective content item. However, other possibilities are contemplated; for instance the location of the subject of the article or content item, such as a restaurant location if the article is a restaurant review, may also be used. A distance between the client device 101, 102 and the content item location as determined may be computed, as one exemplary assessment of the physical proximity.

At 503, a proximity score may be computed, based on the physical proximity assessment. The score, for instance, may be based on the distance in kilometers between the locations determined at 502. An example of a proximity scoring scheme might be as follows:

Using D as the distance in kilometers between the reader or user at their client device location and the author's location when the article or content item was published,

If D<5, then grant an “exact hit” bonus of 100 points

If 5<D<250 then grant a “nearby” bonus of (250/D) points.

If D>250, then subtract a “too far” penalty of negative (D/50) points.

At 504, the age or freshness of the content item since its publication may be computed, typically in hours or days, relative to the time of the user request for community content.

At 505, a numerical score may be assigned based on the freshness of the article. For instance, using N as the number of hours since the article was published,
If N<48, then apply a “freshness” bonus of (48−N) points, rounded to the nearest integer.

If 48<N<168, then no bonus or penalty applies.

If N>168, then apply a “staleness” penalty of negative one point per day beyond 7 days.

At 506, the editorial popularity of the respective content items may optionally be considered. Editorial popularity may be established, for instance, using A as the number of unique commentators, B as the total number of comments, and C as the number of users who have “thumbs-up'ed” or “favorited” the article or content item. Weighting factors X, Y and Z may be sued for each of the A, B and C respectively, for instance X=0.5, Y=0.25 and Z=0.75.

At 507, the popularity score may be computed, for instance as:

(A*X)+(B*Y)+(C*Z), and then rounded up to the nearest integer, as a measure of editorial popularity.

At 508, the uniqueness of the respective content items may be determined. Employing uniqueness as a ranking parameter is intended to ensure that even obscure articles are highlighted as content items, as long as they are relevant in a community context. Also, highlighting unique articles is intended to encourage more development and contribution of community content for a given locality. Uniqueness as used herein means the extent to which a given content item or article is exclusively available its source locality or community, and available at no other place.

At 509, the content items are scored based on uniqueness. For instance, for articles that are both authoritative (original source) and unique (there is no other article exactly like it on the Internet), there might be assigned a bonus. Likewise, a penalty may be applied for articles or content brought in from third party sites such as newspapers and blogs. Such a scheme tends to ensure that unique content gets seen first. There might be typically a negative score adjustment or further penalty applied if a higher the number of other sites on the Internet have the same content. The goal for such a scoring scheme is to ensure that community content gets somewhat higher priority.

At 510, an aggregated score based on the proximity, freshness, and optionally the uniqueness and popularity scores, or any combination thereof, are computed. At this stage, relative weightings of the above scores may be adjusted, to emphasize certain parameters over others. For instance, in a highly populated city with multiple communities or localities within a small area, it might be more desirable to over-emphasize freshness at the expense of physical proximity. It is further contemplated that control over the weightings of any of the four parameters may be provided to a user via web portal application used at client device 101, 102. Such personalization enhances a user's experience in the context of the community content retrieved and presented.

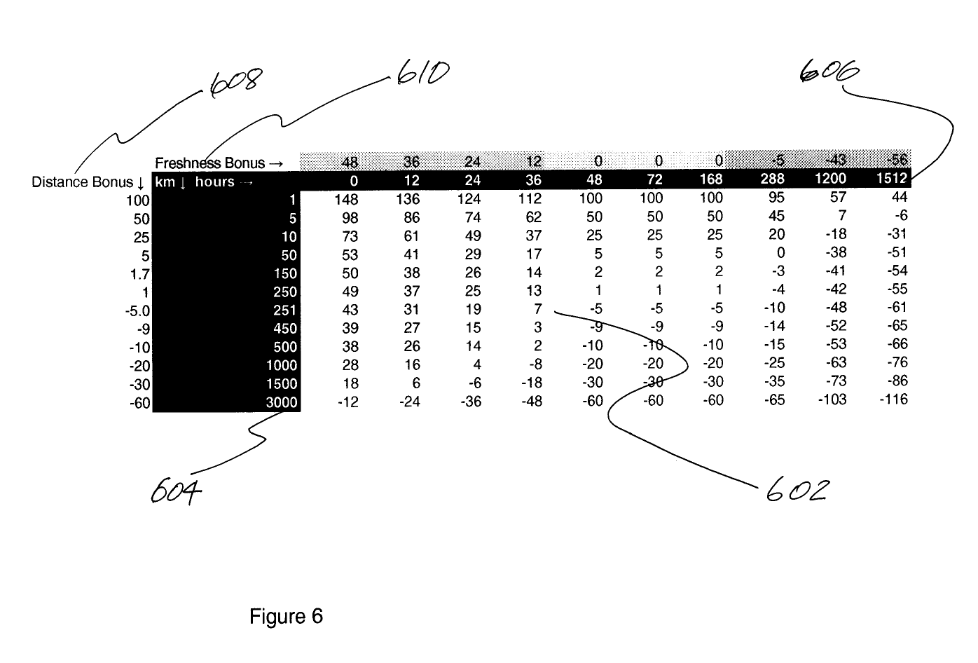

FIG. 6 is an exemplary depicture of how a set of content items among the community-oriented content might be scored to enable ranking of the content items for delivery to a client device. Scores 602 for respective content items scored are shown, based on a vertical axis of distance 604 representing physical proximity, and a horizontal axis of freshness 606 measured in hours since publication of the respective content items. Distance bonus 608 and freshness bonus 610 may be applied as merited, as discussed previously. In this exemplary depicture, the uniqueness and editorial popularity parameters are constant, and are not considered in FIG. 6 for the sake of clarity.

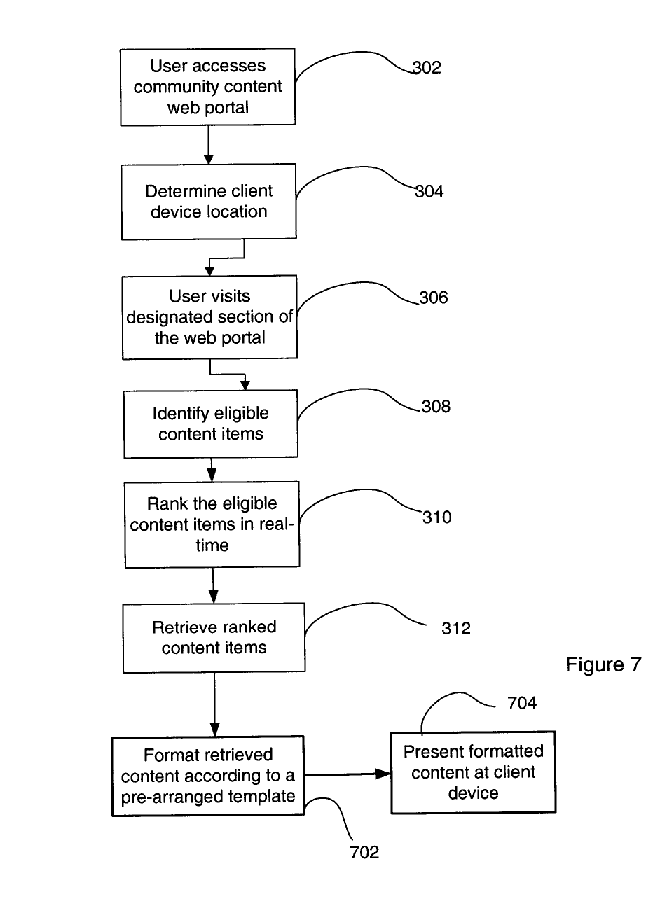

FIG. 7 shows another alternate embodiment of the exemplary methods for accessing, ranking and delivering community-oriented content to a client device. A user-customized format or template may be developed and applied to the content presented at client device, in lieu of presenting the content in the order of the rankings based on the aggregated score. So for instance, a user may have the option to have community news presented in a template or format that reflects their preferences. For instance, presenting the community news in “community newspaper” template, with news of the first page, followed by sports news, then community activities. Such a template might allow for local businesses to provide ads for posting in certain sections of the “community newspaper”. The template may be provided at content control server 106, or allow for complete user customization via an appropriate web portal software application residing at client device 101, 102.

Although preferred embodiments of the invention have been described herein, it will be understood by those skilled in the art that variations may be made thereto without departing from the scope of the appended claims.

What is claimed is:

1. A computer-implemented method, executed in a processor, of retrieving community content, the community content selected from respective ones of content items available at a content database for presentation at a client device, the method comprising:
establishing a physical proximity of the client device to the respective ones of the content items available at the content database;
establishing a freshness of the respective ones of the content items relative to a time of a request for the community content at the client device;
computing an aggregated score for the respective ones of the content items; and
ranking the respective ones of the content items to be presented at the client device according to the respective aggregated score, the aggregated score at least partially based on the physical proximity and the freshness.

2. The method of claim 1 wherein establishing the physical proximity of the client device to respective ones of the content items available at the content database further comprises:
establishing a client device location of the client device requesting retrieval of community content from a content database;
establishing an author location for each of the respective ones of content items at a time of publication of the respective ones of the content items; and
determining a distance between the client device location and each of the respective author locations of the content items.

3. The method of claim 2 further comprising computing a proximity score based on the determined distance.

4. The method of claim 3 further comprising computing the aggregated score at least partially based on the proximity score.

5. The method of claim 1 wherein establishing the freshness of the respective ones of the content items further comprises:
establishing time of publication at the content database of the respective ones of the content items.

6. The method of claim 5 further comprising computing a freshness score based on the freshness of the respective ones of the content items.

7. The method of claim 6 further comprising computing the aggregated score at least partially based on the freshness score.

8. The method of claim 1 further comprising computing the aggregated score at least partially based on a uniqueness score of the respective ones of the content items.

9. The method of claim 1 further comprising computing the aggregated score at least partially based on an editorial popularity score of the respective ones of the content items.

10. The method of claim 1 further comprising:
presenting the ranked content items at the client device according to the rankings.

11. The method of claim 1 further comprising creating a display page at the client device, the display page incorporating the ranked content items in a pre-arranged format for display at the display page.

12. A computer system comprising:
a proximity module to establish a location of a client device requesting retrieval of community content available at a content database and to establish a location of each of the respective ones of content items comprising the community content;
a freshness module to establish a freshness of the respective ones of the content items relative to a time of the request for the community content at the client device; and
a scoring module having program code to rank the content items at the time of the request at the client device;
wherein the content items are ranked for presentation at the client device at least partially based on (i) a physical proximity of the client device to the respective ones of the content items, and (ii) the freshness of the respective ones of the content items.

13. The computer system of claim 12 wherein the scoring module comprises program code to compute an aggregated score for ranking the respective ones of the content items at the time of request for community content from the client device, the aggregated score at least partially based on the physical proximity of the client device to the respective ones of the content items and the freshness of the respective ones of the content items.

14. The computer system of claim 12 wherein the scoring module comprises program code to compute an aggregated score for ranking the respective ones of the content items at the time of request for community content from the client device, the aggregated score at least partially based on a uniqueness score of the respective ones of the content items.

15. The computer system of claim 12 wherein the scoring module comprises program code to compute an aggregated score for ranking the respective ones of the content items at the time of request for community content from the client device, the aggregated score at least partially based on a popularity score of the respective ones of the content items.

16. The computer system of claim 12 further comprising a presentation module, the presentation module for creating a display page at the client device to display the ranked content items according to rankings.

17. The computer system of claim 12 further comprising a presentation module, the presentation module creating a display page at the client device for display of the ranked content items according to a pre-arranged format.
